(19) United States
(12) Patent Application Publication
(10) Pub. No.: US 2010/0096473 A1
(43) Pub. Date: Apr. 22, 2010

(54) Variable flow rate valve for mechnically actuated fuel injector

(75) Inventors: Dana R. Coldren, Secor, IL (US); Koti R. Padarthy, Edwards, IL (US); Michael E. Sattler, Peoria, IL (US); Victor I. Yacoub, Washington, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/288,422

(22) Filed: Oct. 20, 2008

(51) Int. Cl. F02M 47/02

(52) U.S. Cl. 239/90

(57) ABSTRACT

A mechanically actuated electronically controlled fuel injector (MEUI) includes a first electrical actuator that controls the position of a spill valve, and a second electrical actuator to control pressure on a closing hydraulic surface associated with a directly operated needle valve. The fuel injector is actuated via rotation of a cam to move a plunger to displace fuel from a fuel pumping chamber either to a spill passage, or at high pressure out of a nozzle outlet of the fuel injector for an injection event. The minimum controllable fuel injection quantity, especially as it relates to small closely coupled post injections following a large main injection, is accomplished by the inclusion of a variable flow rate valve that restricts fluid flow from a needle control chamber toward a drain, but is relatively unrestricted to high pressure fluid flow toward the needle control chamber. The inclusion of the variable flow rate valve slows the rate at which pressure drops in the needle control chamber to commence an injection event, but permits a fast rate at which pressure may build in the needle control chamber to end an injection event. The result is a smaller post injection quantity and more controllability over the dwell time between injection events.

### TECHNICAL FIELD

The present disclosure relates generally to mechanically actuated electronically controlled fuel injection systems, and more particularly to a variable flow rate valve for a direct operated needle valve, such as to achieve small close coupled post injections.

### BACKGROUND

Mechanically actuated electronically controlled unit injectors (MEUI) have seen great success in compression ignition engines for many years. In recent years, MEUI injectors have acquired additional control capabilities via a first electrical actuator associated with a spill valve and a second electrical actuator associated with a direct operated needle valve. MEUI fuel injectors are actuated via rotation of a cam, which is typically driven via appropriate gear linkage to an engine's crankshaft. Fuel pressure in the fuel injector will generally remain low between injection events. As the cam lobe begins to move a plunger, fuel is initially displaced at low pressure to a drain via the spill valve for recirculation. When it is desired to increase pressure in the fuel injector to injection pressure levels, the first electrical actuator is energized to close the spill valve. When this is done, pressure quickly begins to rise in the fuel injector because the fuel pumping chamber becomes a closed volume when the spill valve closes. Fuel injection commences by energizing the second electrical actuator to relieve pressure on a closing hydraulic surface associated with the direct operated needle valve. The closing hydraulic surface of the directly operated needle valve is located in a needle control chamber which is alternately connected to the pumping chamber or a low pressure drain by moving a needle control valve with the second electrical actuator. Such a control valve structure is shown, for example, in U.S. Pat. No. 6,889,918. The needle valve can be opened and closed any number of times to create an injection sequence consisting of a plurality of injection events by relieving and then re-applying pressure onto the closing hydraulic surface of the needle valve. These multiple injection sequences have been developed as one strategy for burning the fuel in a manner that reduces the production of undesirable emissions, such as NOx, unburnt hydrocarbons and particulate matter, in order to relax reliance on an exhaust aftertreatment system.

One multiple injection sequence that has shown the ability to reduce undesirable emissions includes a relatively large main injection followed closely by a small post injection. Because the needle valve must inherently be briefly closed between the main injection event and the post-injection event, pressure in the fuel injector may surge due to the continued downward motion of the plunger in response to continued cam rotation. In addition, past experience suggests that conditions within the fuel injector immediately after a main injection event are highly dynamic, unsettled and somewhat unstable, making it difficult to controllably produce a small post injection quantity. If the dwell is too short, the post injection quantity is too variant. If the dwell between the main injection event and the post-injection event is too long, the increased pressure in the fuel injector may undermine the ability to produce small post injection quantities but the more stable environment renders the post injection more controllable. In other words, the longer the dwell, the larger the post injection pressure coupled with greater controllability. Thus, the inherent structure and functioning of MEUI injectors makes it difficult to control fuel pressure during an injection sequence because the fuel pressure is primarily dictated by plunger speed (engine speed) and the flow area of the nozzle outlets, if they are open, but the potentially unstable time period immediately after main injection makes any post injection quantity more variable and less predictable. As expected, the pressure surging problem as well as the shrinking post injection timing window can become more pronounced at higher engine speeds and loads, which may be the operational state at which a closely coupled small post injection is most desirable. The inherent functional limitations of known MEUI systems may prevent small close coupled post injections both in desired quantity and timing relative to the end of the preceding main injection event in order to satisfy ever more stringent emissions regulations.

The present disclosure is directed to overcoming one or more of the problems set forth above.

### SUMMARY

In one aspect, a fuel injector includes an injector body that defines a nozzle outlet. A cam actuated plunger is slidably positioned in the injector body and is coupled to a tappet extending outside the injector body. A direct control needle valve includes a closing hydraulic surface exposed to fluid pressure in a needle control chamber, and an opening hydraulic surface exposed to fluid pressure in a nozzle chamber. The plunger and the injector to body define a pumping chamber fluidly connected to the nozzle chamber via a nozzle supply passage. A needle control valve is positioned in the injector body and movable between a first position at which the needle control chamber is fluidly connected to a low-pressure passage, and a second position at which the needle control chamber is fluidly connected to the nozzle supply passage. A variable flow rate valve is positioned in a pressure communication passage that extends between the needle control chamber and the needle control valve.

In another aspect, a method of operating a fuel injector includes closing a spill valve while a plunger of the fuel injector is moving in response to rotation of a cam. A needle valve is opened by fluidly connecting the needle control chamber to a low pressure passage via a pressure communication passage. The needle valve is closed by fluidly connecting the needle control chamber to a nozzle supply passage. The opening step includes configuring a variable flow rate valve in a restricted flow configuration, and the closing step includes configuring the variable flow rate valve in an unrestricted flow configuration.

### BRIEF DESCRIPTION OF THE DRAWINGS

FIG. 1 is a side sectioned diagrammatic view of a fuel injector according to one aspect of the present disclosure;

FIG. 2 is an enlarged side sectioned diagrammatic view of the nozzle control portion of the fuel injector shown in FIG. 1;

FIG. 3 is a further enlarged side sectioned diagrammatic view of the variable flow rate valve of the fuel injector shown in FIG. 1;

FIG. 4 is a top sectioned view of the fuel injector of FIG. 1 as viewed along section line 4-4; and

FIGS. 5a-f represent graphs of a first electrical actuator control signal, spill valve position, a second electrical actuator control signal, needle control chamber pressure, injection pressure, and injection rate, respectively, versus time for an example main plus post injection sequence according to the present disclosure, and with a comparison to a predecessor fuel injector.

### DETAILED DESCRIPTION

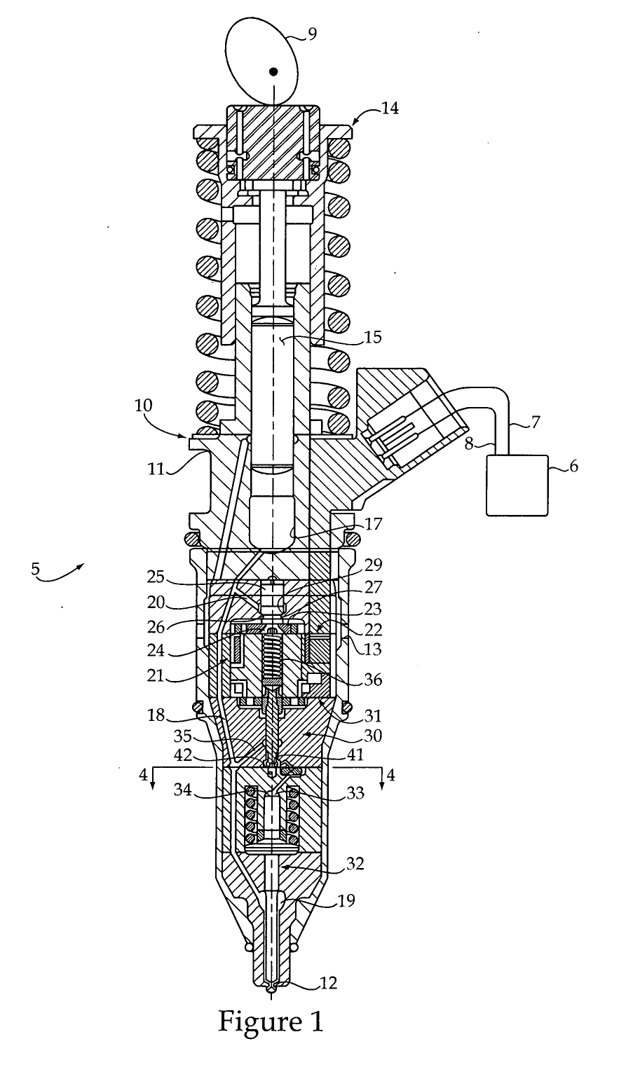

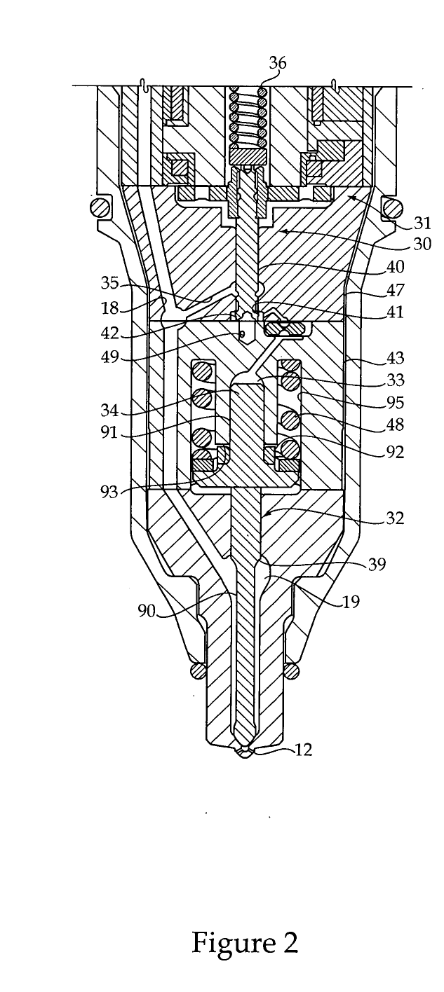

Referring to FIGS. 1 and 2, a fuel system 5 includes a mechanical electronic unit fuel injector 10 that is actuated via rotation of a cam 9 and controlled by an electronic controller 6. Fuel injector 10 includes a first electrical actuator 21 operably coupled to a spill valve 22, and a second electrical actuator 31 operably coupled to a needle control valve 30 to control pressure in a needle control chamber 33. The first and the second electrical actuators 21 and 31 are energized and de-energized via control signals communicated from electronic controller 6 via communication lines 7 and 8, which may be wireless. Fuel injector 10 includes an injector body 11 made up of a plurality of components that together define several fluid passageways and chambers. In particular, a pumping chamber 17 is defined by injector body 11 and a cam driven plunger 15. When plunger 15 is driven downward due to rotation of cam 9 acting on tappet 14, fuel is displaced into a spill passage 20, past spill valve 22, and out a drain passage (not shown) that is fluidly connected to fuel supply/return opening 13. As shown, tappet 14 extends outside of injector body 11. When first electrical actuator 21 is energized, a spill valve member 25 is moved with an armature 23 until a valve surface 26 comes in contact with an annular valve seat 29 to close spill passage 20. When this occurs, fuel pressure in pumping chamber 17 increases, as well as a fuel pressure in nozzle chamber 19 via the fluid connection provided by nozzle supply passage 18. Spill valve member 25 is normally biased to a fully open position via a compression biasing spring 36. Biasing spring 36 also serves to bias the needle control valve 30 to a configuration that fluidly connects needle control chamber 33 to pressure connection passage 35, which is fluidly connected to nozzle supply passage 18.

Pressure in needle control chamber 33 acts upon a closing hydraulic surface 34 associated with needle valve 32. As long as pressure in needle control chamber 33 is high, needle valve 32 will remain in, or move toward, a closed position blocking nozzle outlets 12. When second electrical actuator 31 is energized, needle control valve 30 moves to a position that blocks pressure connection passage 35, and instead fluidly connects needle control chamber 33 to low pressure fuel supply/return opening 13 via a low pressure passage 49 partially shown in FIG. 2. When pressure in needle control chamber 33 is low and pressure in nozzle chamber 19 is above a valve opening pressure (VOP) of the needle valve 32, the needle valve 32 will lift to an open position to allow fuel to spray through nozzle outlets 12 in a conventional manner. The valve opening pressure corresponds to the pressure at which the lifting hydraulic force is greater than the spring 48 preload plus the decaying pressure force acting on the closing hydraulic surface 34.

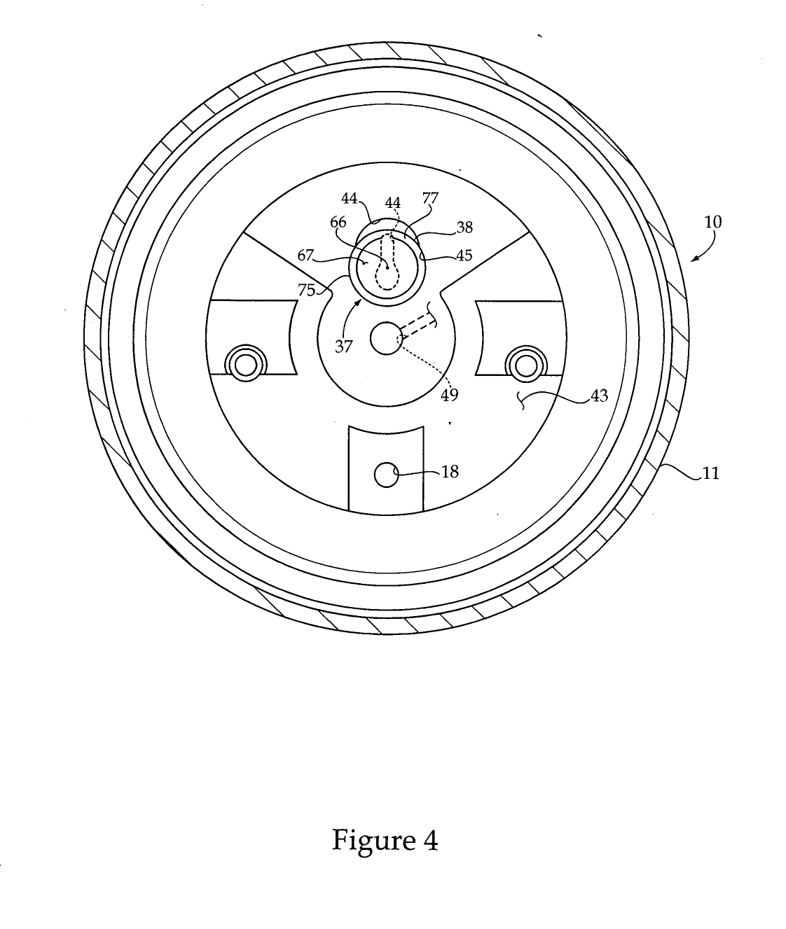

The features associated with nozzle control are shown in greater detail in FIGS. 2-4. In particular, needle control valve 30 includes a control valve member 40 that is normally biased downward into contact with a low-pressure flat seat 42 via the action of biasing spring 36. When in this position, needle control chamber 33 is fluidly connected to nozzle supply passage 18 via connection passage 35, and pressure communication passage 44. When second electrical actuator 31 is energized, control valve member 40 is lifted to open flat seat 42 and close conical high-pressure seat 41. When in this position, needle control chamber 33 is fluidly connected to low-pressure passage 49 via pressure communication passage 44. A variable flow rate valve 37 is located in pressure communication passage 44. Variable flow rate valve 37 has the function of slowing the decay of pressure in needle control chamber 33, while leaving the rate at which pressure may build in needle control chamber 33 relatively unchanged relative to the predecessor fuel injector, which includes an unobstructed pressure communication passage free of any valve structures.

When electrical actuator 31 is de-energized and control valve member 40 is in the downward position to close flat low-pressure seat 42, needle control chamber 33 is fluidly connected to nozzle supply passage 18 via connection passage 35 and pressure communication passage 44. As such, high pressure in nozzle supply passage 18 enters needle control chamber 33 to act upon closing hydraulic surface 34 to hold needle valve 32 in a closed position, or move the same toward a closed position where a check lift spacer 92 may be out of contact with stop surface 93. Pressure in needle control chamber 33 drops when control valve member 40 is lifted to close conical high-pressure seat 41 and open the fluid connection to drain passage 49. The various areas of closing hydraulic surface 34 and opening hydraulic surface 39 are sized such that needle valve 32 will lift and move upward toward its open position in contact with stop surface 93 when pressure in nozzle chamber 19 is above a valve opening pressure associated with the pre-load on biasing spring 48, which normally biases needle valve 32 downward toward a closed position. As shown, the needle control chamber 33, variable flow rate valve 37 and the needle biasing spring 48 may be disposed in a spring cage component 43 of injector body 1. Although needle valve 32 may be of unitary construction, in the illustrated embodiment the needle valve 32 includes a needle 90, a check lift spacer 92 and a piston 91. Together, piston 91 and spring cage component 43 define needle control chamber 33. Also, the needle biasing spring 48 is received in an annular cavity 95 defined by spring cage component 43. Nevertheless, numerous alternative structural details would fall within the intended scoped of the disclosure.

The structure illustrated in FIGS. 1-4 differs from the predecessor injectors at least by the inclusion of the variable flow rate valve 37. As stated before, this feature has the function of quickly ending injection events by allowing pressure to quickly rise in needle control chamber 33 to facilitate an injection event when in an unrestricted flow configuration. In addition, this structure delays or slows the rate at which pressure drops in needle control chamber 33 to begin an injection event relative to predecessor injectors due to movement of variable flow rate valve 37 into a restricted flow configuration. As a consequence, one could expect the needle valve 32 to lift toward an open position slightly slower than predecessor injectors, but close about the same as the counterpart predecessor with identical fuel pressures and control signals. In addition, because the needle control chamber 33 is maintained at a higher pressure level during an injection event, the operation of direct control needle valve 32 is more controllable or responsive than in the counterpart predecessor fuel injector. It is this ability that allows for an improvement over the predecessor injectors by providing a mechanism by which a closely coupled post-injection event can be more controllably accomplished while decreasing the quantity of fuel injected in the post-injection. This combination of the dwell control and post injection quantity reduction has shown the ability to improve emissions over the predecessor fuel injectors that did not include the variable flow rate valve 37. Thus, by the addition of a variable flow rate valve 37 to a predecessor fuel injector, an improvement in emissions reductions may be achieved, especially at those operating conditions that call for injection sequences that include a closely coupled small post injection event.

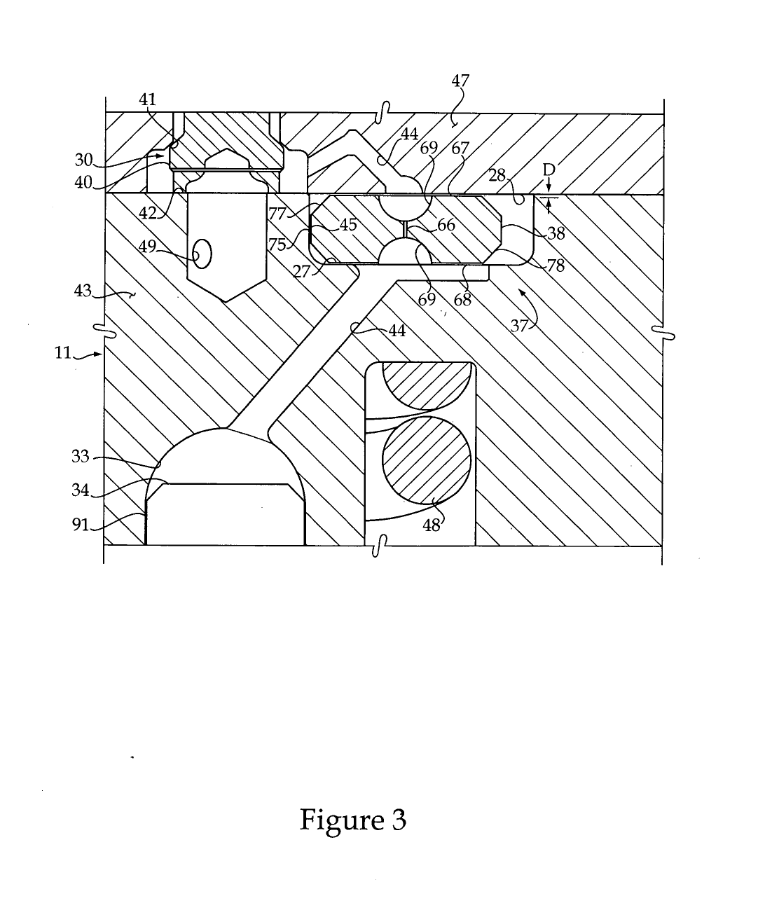

Variable flow rate valve 37 may be configured to include a round plate 38 that is positioned for guided movement in any guide bore 45 defined by spring cage component 43 between the a downward position, as shown in FIG. 3, and an upward position. In particular, plate 38 includes a cylindrically shaped guide surface 75 that has a relatively tight clearance with guide bore 45 in order to guide movement of plate 38 between a lower position where a bottom surface 68 is in contact with a first stop 27, and an upward position where a top surface 67 is in contact with a second stop 28. Top surface 67, bottom surface 68, first stop 27 and second stop surface 28 may be planar surfaces. Plate 38 may move a travel distance D between first stop 27 and second stop 28. The bottom surface 68 is separated from the cylindrical guide surface 75 by a lower bevel surface 78, whereas the top surface 67 of plate 38 is separated from guide surface 75 by a top bevel surface 77. Those skilled in the art will appreciate that in the context of the present disclosure, the term “bevel” means any removal of sharp cornered surfaces and need not necessarily relate only to a frustoconical shape, but may also include rounded edges or any other shape that breaks the corner.

When plate 38 is in contact with first-stop 27, fluid may flow into pressure communication passage 44 toward needle control chamber 33 via an orifice 66 defined by plate 38 and also along one portion of its outer edge and adjacent bottom bevel surface 78. Plate 38 may include indentations 69 to make orifice 66 easier to manufacture at a length that is less than a thickness of plate 38. When plate 38 is in the upward position in contact with second stop 28, the first communication passage 44 is configured to limit flow only through orifice 66. Thus, when plate 38 is in the lower position in contact with first stop 27, the plate 38 may be said to be in an unrestricted flow configuration because fluid flow in pressure communication passage 44 has a relatively large flow area due to the combined flow area through orifice 66 and around the edge of lower bevel surface 78. On the other hand, when plate 38 is in the upper position in contact with second stop 28, the plate 38 may be said to be in a restricted flow configuration because the flow is limited or restricted to orifice 66. Although variable flow rate valve 37 is illustrated as including a round plate, those skilled in the art will appreciate that other valve configurations would fall within the intended scope of the present disclosure, provided they could be configured in a relatively restricted configuration and a relatively unrestricted configuration.

In the illustrated structure, several design considerations are available for adjusting the operation of the nozzle control features and the operation of fuel injector 10. These design considerations allow some influence over the rate at which pressure may drop in needle control chamber 33 relative to the rate at which pressure may be increased in the same. Among the design considerations are the flow area of orifice 66. As expected, as the flow area decreases, the rate at which pressure may drop in needle control chamber 33, and hence the rate at which the needle valve 32 may open, is slowed. On the other hand, if the area for orifice 66 is made too large, there may not even be a flow restriction, and the fuel injector might exhibit very little difference in behavior relative to the predecessor fuel injector. A couple of related design considerations relate to the volume of the needle control chamber 33 (fuel compressibility) along with the travel distance D, which corresponds to a volume swept out by movement of plate 38. For instance, if the travel distance is made too large or the chamber volume too large, the variable flow rate valve 37 may again have little to no effect on the action of the fuel injector relative to the predecessor, at least in regard to close coupled post injections. On the other hand, if the travel distance is made too small, there may be difficulty in mass production of fuel injectors that include a variable flow rate valve with consistent behavior. Between these two extremes may lie a range of travel distances that show a dramatic change between the behavior of the predecessor fuel injector and a slowed pressure drop action in needle control chamber 33.

### INDUSTRIAL APPLICABILITY

The present disclosure finds potential application to any fuel system that utilizes mechanically actuated electronically controlled fuel injectors with at least one electrical actuator operably coupled to a spill valve and a needle valve. Although both the spill valve and the needle valve may be controlled with a single electrical actuator within the intended scope of the present disclosure, a typical fuel injector according to the present disclosure includes a first electrical actuator associated with the spill valve and a second electrical actuator associated with the needle valve. Any electrical actuator may be compatible with the fuel injectors of the present disclosure, including solenoid actuators as illustrated, but also other electrical actuators including piezo actuators. The present disclosure finds particular suitability in compression ignition engines that benefit from an ability to produce injection sequences that include a relatively large main injection followed by a closely coupled small post-injection, especially at higher speeds and loads in order to reduce undesirable emissions at the time of combustion rather than relying upon after-treatment systems. The present disclosure also recognizes that every fuel injector exhibits a minimum controllable injection event duration, below which behavior of the injector becomes less predictable and more varied.

The minimum controllable injection event duration for a given fuel injector relates to that minimum quantity of fuel that can be repeatedly injected with the same control signal without substantial variance. This phenomenon recognizes that in order to perform an injection event, certain components must move from one position and then back to an original position with some predictable repeated behavior in order to produce a controllable event. When the durations get too small, pressure fluctuations are too large and components are less than settled, components tend to exhibit erratic behavior due to flow forces, pressure dynamics and possibly mechanical bouncing before coming to a stop and other phenomena that give rise to nonlinear and erratic behavior at various short and small quantity injection events. The present disclosure is primarily associated with the minimal controllable injection event, especially when such an event occurs after a large main injection event. Thus, the present disclosure recognizes that simply decreasing the duration of the post-injection event may theoretically produce a smaller injection quantity, but the uncontrollable variations on that quantity may become unacceptable, thus defeating that potential strategy for producing ever- smaller injection event quantities.

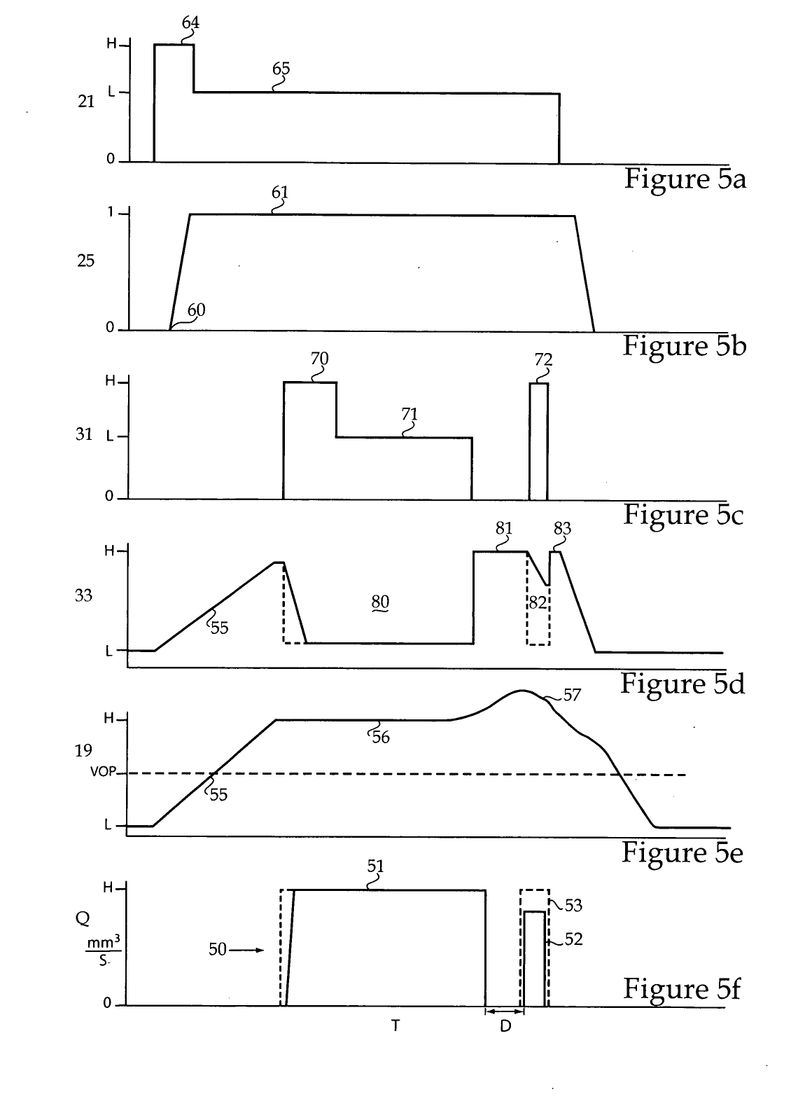

Referring now to FIGS. 5a-f, an injection sequence 50 that includes a large main injection 51 and a closely coupled small post injection 52 is shown in FIG. 5f. Also shown is a similar result with a large post injection 53 according to the predecessor fuel injector that does not include a variable flow rate valve 37. The injections in FIGS. 5f utilize the same control signals, but the predecessor fuel injector's behavior is shown by dotted lines in FIGS. 5d and 5f. Any injection sequence generally begins when the lobe of cam 9 starts to move plunger 15. As plunger 15 begins moving, first electrical actuator 21 is energized to a pull-in current 64 (FIG. 5a) to close spill valve 22. As cam 9 continues to rotate, pressure in nozzle chamber 19 begins to ramp up as per pressure increase 55 shown in FIG. 5e. The closure of spill valve 22 is reflected in FIG. 5b by the movement of spill valve member 25 from a fully open position 60 to a closed position 61. At this time, second electrical actuator 31 remains de-energized to facilitate a fluid connection via pressure connection passage 35 and pressure communication passage 44 to needle control chamber 33 so that the pressure therein tracks closely with the pressure increase 55 as shown in FIG. 5d. After spill valve member 25 comes to rest at the closed position, the current or control signal to electrical actuator 21 may be dropped to a hold-in level 65 (FIG. 5a) that is sufficient to hold spill valve member 25 in the fully closed position 61 as shown in FIG. 5b.

When it comes time to initiate the main injection event 51, second electrical actuator 31 is energized to a pull-in current level 70 (FIG. 5c) that moves needle control valve 30 to a position that closes pressure communication passage 35, but opens needle control chamber 33 to a low pressure drain passage 49. When this occurs, pressure on top surface 67 of plate 38 is relieved, but high pressure remains on lower surface 68. Due to the slight compressibility of fuel, and the pressure differential across plate 38 the fuel in needle control chamber 33 will expand, and the plate 38 quickly rises to the upper position in contact with second stop 28. Thus, a movement of plate 38 from the lower position to the upper position may occur almost immediately after needle control valve number 40 lifts off of low pressure flat seat 42, and it may occur before needle valve 32 moves away from the closed position. This phenomenon may be attributed primarily to the slight compressibility of the fuel located in needle control chamber 33 and the portion of pressure communication passage 44 located below plate 38. In the predecessor fuel injector, pressure drops rapidly in needle control chamber 33 as shown by the dotted line in FIG. 5d allowing the needle valve 32 to open quicker as shown in FIG. 5f than in the fuel injector 10 of the present disclosure. This occurs because flow in the predecessor fuel injector from needle control chamber 33 toward low-pressure passage 49 is relatively unrestricted. On the other hand, in the case of the present disclosure, the pressure in needle control chamber 33 drops more gradually as shown in FIG. 5d due to the forcing of fluid through flow restriction orifice 66, resulting in a slight delay in the opening of needle valve 32 relative to the predecessor fuel injector, as shown in the beginning of main injection event 51 in FIG. 5f. When pressure in nozzle chamber 19 goes above the valve opening pressure (VOP) as shown in FIG. 5e, needle valve 32 will lift, and fuel will commence to spray out of nozzle outlets 12 for main injection event 51. As with first electrical actuator 21, second electrical actuator 31 may have the control signal dropped to a low or hold-in current level 71 after the control valve member 40 has come to rest at high pressure seat 41. The main injection event 51 may be terminated by de-energizing second electrical actuator 31 to increase pressure in needle control chamber 33 as shown at 81 in FIG. 5d. This results in the abrupt closure of needle valve 32 to end injection through nozzle outlets 12. As shown in FIG. 5f, the end of main injection 51 is nearly identical for both the present fuel injector 10 and a predecessor fuel injector.

Between the injection events, pressure begins to increase as per pressure surge 57 (FIG. 5e) during the dwell D (FIG. 5f) between main injection event 51 and the post injection event 53. Thus, fuel pressure at the time of post-injection event 53 is relatively high due to pressure surge 57 resulting in a larger than desirable post injection quantity 53 in the predecessor fuel injector. The small post injection event 52 is accomplished by re-energizing the second electrical actuator 31 as shown at 72 in FIG. 5c to drop pressure in needle control chamber 33 as shown at region 82 of FIG. 5d. Thereafter, second electrical actuator 31 is de-energized to again increase pressure in needle control chamber 33 to end the injection sequence 50. A subtle but important phenomenon is illustrated in the region 82 shown in FIG. 5d. In particular, the smaller post-injection event quantity 52 relative to the post-injection quantity 53 of the predecessor fuel injector is accomplished by a combination of features associated with variable flow rate valve 37. First, because pressure in needle control chamber 33 drops more slowly relative to the predecessor fuel injector, the post injection event 52 starts later in time than it's counterpart post-injection event 53. In addition, the duration of the post-injection event may be so short that the needle valve 32 may not even reach its fully open position before the needle control valve 33 is moved back to close low pressure seat 42 as shown by region 83 in FIG. 5d. Finally, the post-injection event duration may be sufficiently short that pressure in region 82 never reaches the same lower levels of that shown by the dotted line associated with the predecessor fuel injector before pressure again is driven to rise to end the post-injection event. The result being as shown in FIG. 5f that the post-injection event 52 starts later, ends earlier and has a smaller peak than the counterpart post-injection event 53 associated with the predecessor fuel injector. Those skilled in the art will appreciate that the injection event could also conceivably be ended by the lobe of cam 9 passing its peak, or by opening spill valve 22 to relieve pressure in fuel injector 10 to below the valve closing pressure sufficient to maintain needle valve 32 in its open position. The valve closing pressure and the valve opening pressure (VOP) may be similar in magnitude.

The present disclosure has the advantage of achieving smaller post injections 52 following relatively large main injections 50 with an increased, decreased or same dwell D between injection events. A smaller quantity post injection 52 may achieve better emissions with only a small change to existing hardware, namely, the inclusion of variable flow rate valve 37. Those skilled in the art will recognize that the addition of variable flow rate valve 37 could be utilized to reduce the post injection quantity even if the dwell were matched or reduced relative to that of the predecessor fuel injector via a suitable adjustment to the control signal for the second electrical actuator 31. The presence of variable control rate valve 37 also reduces the magnitude of the pressure swings that occur in needle control chamber 33 during the post-injection event 52, and this aspect may enhance the controllability of the post-injection event relative to the predecessor fuel injector. This enhanced controllability may also permit designers to select a dwell D that may be shorter, the same or longer than what is consistently possible with the predecessor fuel injector. In summary, the variable flow rate valve 37 may allow for a decrease in the post injection quantity 52 over the predecessor post-injection quantity 53 (FIG. 5f), and also an improvement in the ability to select a duration for the dwell D, even in the face of pressure surge 57 that occurs between the injection events. The result may be better emissions reduction than an otherwise equivalent fuel system application. Those skilled in the art, however, might take note that control signals might need to be adjusted across the engine's operating range to accommodate for the slower opening behavior of the needle valve 32 at all operating conditions due to the inclusion of the variable flow rate valve 37. The phrase “variable flow rate” refers to a fluid passage that is relatively restrictive to fluid flow in one direction, but relatively unrestricted to flow in an opposite direction.

Although the present disclosure has been illustrated in the context of an injection sequence that includes a large main injection followed by a small post injection, it is foreseeable that the same techniques could be utilized to reduce the minimum controllable injection quantity of fuel injector 10 for any injection event alone or as part of a sequence. For example, the added capabilities provided by variable flow rate valve 37 could be exploited at other operating conditions, such as to produce small split injections at idle. And in addition, smaller pilot injections may also be available via the inclusion of the variable flow rate valve 37. Thus, the ability to incrementally decrease the minimum controllable fuel injection quantity at all operating conditions and pressures could conceivably be exploited in different ways across an engine's operating range apart from the illustrative example that included an injection sequence with a large main injection followed by a closely coupled post injection.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A fuel injector comprising:
an injector body that defines a nozzle outlet;
a cam actuated plunger slidably positioned in the injector body and being coupled to a tappet extending outside the injector body;
a direct control needle valve that includes a closing hydraulic surface exposed to fluid pressure in a needle control chamber, and an opening hydraulic surface exposed to fluid pressure in a nozzle chamber;
the plunger and the injector body defining a pumping chamber fluidly connected to the nozzle chamber via a nozzle supply passage;
a needle control valve positioned in the injector body and being movable between a first position at which the needle control chamber is fluidly connected to a low pressure passage, and a second position at which the needle control chamber is fluidly connected to the nozzle supply passage; and
a variable flow rate valve positioned in a pressure communication passage that extends between the needle control chamber and the needle control valve.

2. The fuel injector of claim 1 wherein the variable flow rate valve includes a plate movable a travel distance between a first stop and a second stop;
the pressure communication passage having an unrestrictive flow area when the plate is in contact with the first stop, but having a restrictive flow area when the plate is in contact with the second stop.

3. The fuel injector of claim 2 wherein the first stop is a first planar surface of a first injector body component of the injector body;
the second stop is a second planar surface of a second injector body component of the injector body; and
the plate defines an orifice therethrough.

4. The fuel injector of claim 2 wherein the plate has a side guide surface separated from the injector body by a guide clearance.

5. The fuel injector of claim 4 wherein the first stop is a first planar surface of a first injector body component of the injector body;
the second stop is a second planar surface of a second injector body component of the injector body; and
the plate defines an orifice therethrough.

6. The fuel injector of claim 5 wherein the guide surface includes at least a portion of a cylinder.

7. The fuel injector of claim 6 wherein a top surface of the plate is separated from the guide surface by a top beveled surface; and
a bottom surface of the plate is separated from the guide surface by a bottom beveled surface.

8. The fuel injector of claim 7 wherein the guide surface defines a cylinder.

9. The fuel injector of claim 1 further including an electrical actuator positioned in the injector body and operably coupled to the needle control valve;
the needle control valve includes a control valve member in contact with a conical valve seat at the first position, and in contact with a flat valve seat at the second position;
the electrical actuator is a first solenoid;
a spill valve positioned in the injector body and being movable between an open position at which a spill passage fluidly connected to the pumping chamber is open, and a closed position at which the spill passage is closed; and
a second solenoid positioned in the injector body and operably coupled to the spill valve

10. The fuel injector of claim 9 further including a shared biasing spring operably positioned to bias the needle control valve toward the second position and the spill valve toward the open position.

11. A method of operating a fuel injector, comprising the steps of:
closing a spill valve while moving a plunger of the fuel injector in response to rotation of a cam;
opening a needle valve by fluidly connecting a needle control chamber to a low pressure passage via a pressure communication passage;
closing the needle valve by fluidly connecting the needle control chamber to a nozzle supply passage;
the opening step includes configuring a variable flow rate valve in a restricted flow configuration; and
the closing the needle valve step includes configuring the variable flow rate valve in an unrestricted flow configuration.

12. The method of claim 11 wherein the step of configuring the variable flow rate valve in a restricted flow configuration includes moving a plate a travel distance from a first stop to a second stop; and
the step of configuring the variable flow rate valve in an unrestricted flow configuration includes moving the plate the travel distance from the second stop to the first stop.

13. The method of claim 12 wherein the opening step and the closing the needle valve step include moving fuel through an orifice defined by the plate in a first direction and a second direction, respectively.

14. The method of claim 13 wherein the moving steps includes guiding the plate via an interaction between a guide surface of the plate with a bore wall of an injector body.

15. The method of claim 14 wherein the step of configuring the variable flow rate valve in a restricted flow configuration includes positioning the plate in contact with a second planar surface; and
the step of configuring the variable flow rate valve in an unrestricted flow configuration includes positioning the plate in contact with a first planar surface.

16. The method of claim 15 further including injecting fuel via the needle valve for a first injection event of a plurality of injection events in an injection sequence prior to the opening step; and
injecting fuel via the needle valve for a second injection event in the injection sequence responsive to the opening step.

17. The method of claim 16 wherein the first injection event is a main injection; and
the second injection event is a post injection.

18. The method of claim 17 further including a step of maintaining the spill valve closed between the first and second injection events;
wherein a main injection quantity corresponding to the first injection is greater than a post injection quantity corresponding to the second injection.

19. The method of claim 18 wherein the opening step is accomplished by energizing a first electrical actuator;
the step of closing the spill valve includes energizing a second electrical actuator.

20. The method of claim 19 wherein the step of opening the needle valve includes moving a control valve member out of contact with a flat valve seat and into contact with a conical valve seat.
